(19) United States
(12) Patent Application Publication
(10) Pub. No.: US 2023/0252267 A1
(43) Pub. Date: Aug. 10, 2023

(54) ATTENTION MECHANISM AND DATASET BAGGING FOR TIME SERIES FORECASTING USING DEEP NEURAL NETWORK MODELS

(71) Applicant: PAYPAL, INC., San Jose, CA (US)

(72) Inventors: Moein Saleh, Campbell, CA (US); Chiara Poletti, San Jose, CA (US); Xing Ji, San Jose, CA (US)

(21) Appl. No.: 17/667,406

(22) Filed: Feb. 8, 2022

(51) Int. Cl. G06N 3/04; G06N 3/08

(52) U.S. Cl. CPC G06N 3/0445; G06N 3/08; G06Q 10/04

(57) ABSTRACT

There are provided systems and methods for an attention mechanism and dataset bagging for time series forecasting using deep neural network models. A service provider, such as an electronic transaction processor for digital transactions, may provide computing services to users. In order to provide time series forecasting for users, accounts, and/or activities associated with the service provider, the service provider may provide time series forecasting where future predictive forecasts of a variable are performed at future timesteps. The time series forecasting may be optimized for deep neural networks using data bagging, where multiple subsets of training data are used to train multiple models for ensemble learning. Further, an attention mechanism may be used to focus on specific past timesteps of relevance, such as those timesteps that correspond to the forecasted timestep. External features may be used to provide forecasting based on external data relevant to the forecasted timestep.

### TECHNICAL FIELD

The present application generally relates to deep neural network (DNN) and other machine learning (ML) models for predictive forecasting, and more particularly to using an attention mechanism for timestep focus and data bagging with training data to provide more accurate DNN models during time series forecasting.

### BACKGROUND

Online service providers may provide services to different users, such as individual end users, merchants, companies, and other entities. For example, online transaction processors may provide electronic transaction processing services. When providing these services, the service providers may provide an online platform that may be accessible over a network, which may be used to access and utilize the services provided to different users. The service providers may use intelligent decision-making operations to attempt to forecast and/or predict data for customers, merchants, and other entities. For example, the service provider may attempt to forecast a customer's future interests, revenue, regions or markets, and other potential actionable engagements. However, traditional temporal and time series forecasting is challenging due to issues with variability of temporal data, which may change due to short-term trends, seasonal factors, long-term trends, and other external factors. Conventional temporal and time series forecasting suffers from issues in accuracy due to these challenges and may not adequately consider certain factors and/or temporal data. Even small inaccuracies in forecasting may have significant effects when predicting actionable data.

Therefore, there is a need for a more accurate and efficient intelligent systems for predicting future data during temporal and time-series forecasting.

### BRIEF DESCRIPTION OF THE DRAWINGS

FIG. 1 is a block diagram of a networked system suitable for implementing the processes described herein, according to an embodiment;

FIGS. 2A and 2B are exemplary architectures of a time series model providing predictive forecasts of total payment volumes at future times, according to embodiments;

FIG. 3 is an exemplary deep neural network used for time series forecasting, according to an embodiment;

FIG. 4 is a flowchart for an attention mechanism and dataset bagging for time series forecasting using deep neural network models, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for an attention mechanism and dataset bagging for time series forecasting using deep neural network models. Systems suitable for practicing methods of the present disclosure are also provided.

In networked computing systems, such as online platforms and systems for service providers, electronic platforms and computing architectures may provide computing services to users and their computing devices. For example, online transaction processors may provide computing and data processing services for electronic transaction processing between two users or other entities (e.g., groups of users, merchants, businesses, charities, organizations, and the like). In order to assist in providing computing services to users, customers, merchants, and/or other entities, services providers may provide time series or temporal forecasting based on temporal or time-based data. This allows for performing decision-making and predictions at future times and/or timesteps in order to provide actionable decisions on extensions of computing services and the like. In order to do so, a service provider may utilize neural networks (NNs), DNNs including long short-term memory (LSTM) recurrent neural network architectures, ML models, and/or other artificial intelligence (AI) systems. However, time series forecasting for predictive forecasts is difficult and prone to error. Thus, service providers may not properly train and tune conventional DNN and other ML models for proper time series forecasting.

In this regard, a service provider may utilize a trained DNN model, such as one using an LSTM architecture, that includes an attention mechanism to focus on particular past timesteps and/or time-based/temporal data when training the DNN to predict future timesteps and corresponding forecasts. Feature data may include or be accessed from data records for data in one or more data tables that include different parameters and/or features. For example, a data record for different feature data for a user, account, activity, or the like may include or correspond to a row in a data table having features for the DNN that correspond to the different columns of the data table. A user may have a record that may include an account, a processed transaction, an amount, transaction items, etc., which may be found in the columns for the corresponding data record in a row.

The features and/or data records may also have a corresponding temporal factor, dimensionality, and/or information, such as actions taken over a time period (e.g., processed transactions over a time period, changing account balance, etc.). Further, different data records may also include different feature data at different points in time or timesteps, such as data occurring on a particular day of week (e.g., Monday), a selected time period or time in the past (e.g., one week time period or one week ago), in a particular month or other time (e.g., January, a year such as 2021, a season, or the like). Initially, the service provider may train the DNN model using training data to perform these time-based predictions, classifications, and/or categorizations. When training, training data may be used for these features, as well as additional external features that may be specifically selected for a time series forecasting task. For example, external features may include those associated with additional customer data, fraud data, transaction data, a macro-economical feature, a trend in an e-commerce industry, a pandemic effect feature, a total payment volume migration feature, or a combination thereof. Thus, these features may provide additional time-based data that may have a temporal nature and affect predictive forecasting at future timesteps/times

Conventional time series forecasting by service providers may be inaccurate or have difficulties properly processing and training on time-based data. As discussed herein, a service provider may utilize a DNN model and/or framework to provide deep temporal-based time series forecasting. The DNN model may use an LSTM recurrent neural network architecture, where an attention mechanism is used to focus on particular past timesteps and/or other external data as having an additional weight, focus, or value on predicting a future forecast at a future timestep. Other NN, ML, and/or AI systems and models may also be used. Data bagging, also referred to as aggregating or bootstrap aggregation, may be used to train multiple different DNN or ML models, which may be combined and/or otherwise processed in order to learn and obtain a better model. Thus, data bagging may be used to generate subsets of training data from a larger set of training data by selecting, or “bagging”, a set of data records from the training data. Thereafter, multiple DNN models may be trained and combined for enhanced accuracy and/or robustness.

The DNN model may be trained for a predictive score, classification, or output variable associated with input features, where the output is associated with a predictive forecast. The predictive forecast may be associated with one or more main input variables or features, such as a customer revenue, a total payment volume, or the like. The predictive output, such as the score, decision, or other value, may further be used to predict other information associated with an account, user, activity, or the like based on the training data. Thereafter, a recommendation, action, or assessment may be provided that may be associated with additional computing services, information, value, and the like for users, accounts, and/or entities.

For example, a service provider may provide electronic transaction processing to users and entities through digital accounts, including consumers and merchants that may wish to process transactions and payments and/or perform other online activities. The service provider may also provide computing services, including email, social networking, microblogging, media sharing, messaging, business and consumer platforms, etc. In order to establish an account, these different users may be required to provide account details, such as a username, password (and/or other authentication credential, such as a biometric fingerprint, retinal scan, etc.), and other account creation details. The account creation details may include identification information to establish the account, such as personal information for a user, business or merchant information for another entity, or other types of identification information including a name, address, and/or other information. The entity may also be required to provide financial or funding source information, including payment card (e.g., credit/debit card) information, bank account information, gift card information, benefits/incentives, and/or financial investments, which may be used to process transactions. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services.

An online transaction processor or other service provider may execute operations, applications, decision services, and the like that may be used to process transactions between two or more users or entities. When providing computing services to users or other entities, as well and making other business decisions, the service provider may utilize intelligent time series forecasting based on data occurring at different past timesteps to provide actionable recommendations, actions, marketing or advertisements, and the like in a predictive manner. Initially, the service provider may train a DNN or other ML model for a predictive output or classification associated with one or more future timesteps. In order to train the DNN or other ML models, training data for the models may be collected and/or accessed. The training data may correspond to a set or collection of features from some input data records, which may be associated with users, customers, accounts, activities, entities, and the like. The training data may further have a temporal factor or dimension such as by changing over a time period and/or having data related to specific points in time or timesteps (e.g., intervals or time period, which may be part of a longer time period, such as hours of a day, a day of the week or month, etc.).

The training data may be collected, aggregated, and/or obtained for a particular predictive output and/or classifications by the DNN. For example, a DNN may be associated with providing predictive forecasts of a user's, business entity's, or account's future behavior, activity, actions, incoming or outgoing funds or data, value, engagement, or the like. In some embodiments, the DNN may be used to classify users as engaged or not engaged with the service provider (e.g., based on past behaviors and the like), if users are predicted to engage in or be the victim of fraud, an entity's future value, and the like. The training data may therefore have data records, where the data records may correspond to particular past timesteps and therefore have a temporal factor or dimension. The training data may also include multiple data records for different timesteps over a time period, which allows for analysis of the temporal data over a time period and learning to predict future forecasts.

When training the DNN model, such as the LSTM model, an attention mechanism may be utilized to draw focus to particular timesteps and/or other features that may be of particular importance to the future predictive forecast. For example, a past timestep for a total payment volume (TPV) on a Monday may be of particular relevance to predicting a forecasted TPV for a future Monday. Similarly, a past seasons revenue may be of relevant to the same future season's predicted revenue. When using the attention mechanism, an additional or adjusted weight, value, or the like may be used during training from the input features (e.g., the feature(s) for the past timestep that has additional attention or focus from the attention mechanism), which may adjust weights and/or values for different nodes, layers, and/or connections between nodes/layers in the DNN. This may allow for training that focuses on particular timesteps of relevance to future predictive forecasts. Further, the attention mechanism may also be used during predictive forecasting in order to highlight the particular past timestep(s) of importance to the future predictive forecast. While an attention mechanism may be used to draw particular attention to and further weigh past timesteps and/or corresponding features occurring on those timesteps (e.g., total payment volume, revenue, other activities, user or account data, etc.), other external features may also be used with the attention mechanism. Thus, the attention mechanism may utilize multiheaded attention and/or multiple attention layers for different features. For example, an external feature related to seasonal changes may also be focused with the attention mechanism as particularly relevant to seasonal revenue.

While training, data bagging, or bootstrap aggregating, may also be used to generate subsets of training data that may be used to train different DNN models, such as multiple LSTM recurrent neural network architecture models, where a combination of such models may be used for a testable and/or deployable model. For example, data bagging takes input data tables and data records for the training data and utilizes those records to generate subsets of tables and records. Each “bagged” data set resulting from a subset of the data records for the training data may each be individually used to train a DNN or other ML model, and the individually trained DNN or other ML models may be combined through ensemble learning to provide a more accurate and/or robust model. The different bagged data sets may include records randomly selected in order to reduce noise or procedurally selected based on a DNN modeler's configuration. When data bagging, not all data records are required to be used and data records may overlap between different subsets of the training data used for training; however, this may also be configurable to use all data records and/or prevent overlapping of data records. The data bagging process and configurations may be helpful to reduce noisy data sets that may otherwise affect training of a single DNN model.

When training the DNN model for predictive forecasts of a future traits, features, or variables, additional external features may be utilized in order to provide additional accuracy, temporal relevance, and/or feature dependence. External features may correspond to segments of temporal data that may affect the main input attribute or feature. For example, with total payment volume, a future revenue, a purchase amount, or a transaction parameter (or any combination thereof), external features may include customer data, fraud data, transaction data, a macro-economical feature, a trend in an e-commerce industry, a pandemic effect feature, or a total payment volume migration feature (or any combination thereof). External feature may therefore be used to provide additional context or factors that may assist in explaining past trends and predicting future forecasts for a particular variable.

Once the training data set(s) and any attention mechanism focus(es) have been determined, the training data for the DNN may be used to train the DNN using a DNN training architecture and framework. In this regard, an LSTM training framework may be used to train an LSTM model, where during training additional operations may be performed in order to optimize the LSTM or other DNN model for time series forecasting. These additional operations may include utilization of the attention mechanism, as well as use of multiple trained DNN models based on data bagging for ensemble training of a resulting DNN with external features. Training may be done by creating mathematical relationships based on the DNN or LSTM algorithm to generate predictions and other decision-making, such as a predictive score or classification for a future forecast at a future timestep. The DNN model trainer may perform feature extraction to extract features and/or attributes used to train the DNN model. For example, training data features may correspond to those data features which allow for decision-making by nodes of a DNN model. In this regard, a feature may correspond to data that may be used to output a decision by a particular node, which may lead to further nodes and/or output decisions by the DNN model. LSTM may be used in order to provide a temporal dimension to the input feature data and corresponding features or variables. Once trained, the DNN may be deployed for time series forecasting of predictive forecasts.

Predictive forecasts may then be generated based on input feature data for a user, account, entity, or the like. The predictive forecasts may be to forecast a variable, trait, feature, or some other data for the user, account, entity, or the like at a future time or timestep. This may be used for different purposes. For example, with a business entity, future quarterly (or other timestep data) earnings, revenue, etc., may be predicted, which may be used for planning and/or business guidance and value (e.g., stock price, investments, etc.). The predictive forecasts may include forecasts of revenues for users, merchants, or the like based on customers, regions, or other markets that e-commence and other companies may request and analyze on a recurrent basis. Other uses may include future search engine or other online resource usage, including predictions for computing resource availability and bandwidth usage, as well as users on a social media or networking platform and/or user outreach. Additionally, events and/or promotional messages may be transmitted to users, accounts, or entities based on predictive forecasts. In some embodiments, these may include a promotional activity or message for a next-best-action based on the users' predictive forecast. Thus, the service provider may provide automated and intelligent time series forecasting in a more accurate manner with expanded feature usage and consideration. By performing better time series forecasting, the service provider may provide improved predictive services and data processing systems through intelligent DNN model performance.

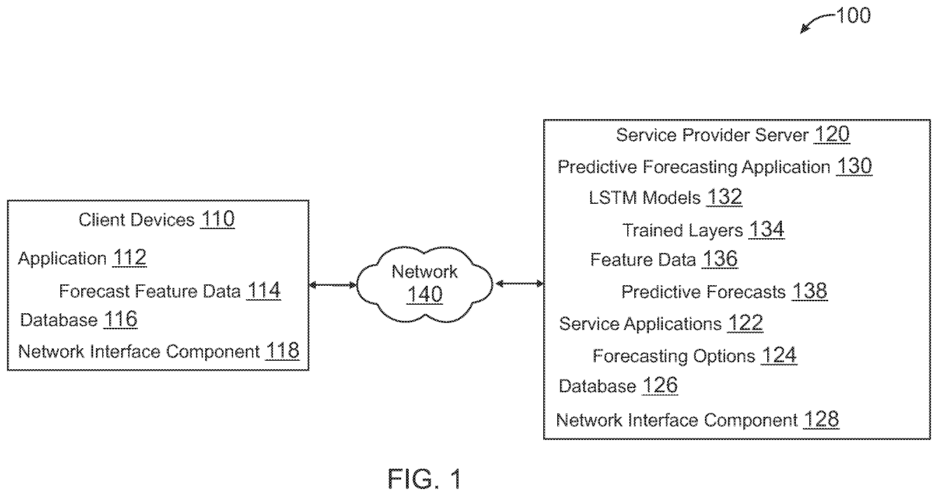

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes client device 110 and a service provider server 120 in communication over a network 140. Client device 110 may be utilized by users or other entities to interact with service provider server 120 over network 140, where service provider server 120 may provide various computing services, data, operations, and other functions over network 140. In this regard, client device 110 may perform activities with service provider server 120 for account establishment and/or usage, electronic transaction processing, and/or other computing services. Service provider server 120 may receive feature data for a DNN that corresponds to data records associated with a user, account, or the like. Service provider server 120 may provide time series forecasting using a DNN, such as an LSTM architecture network, that is trained using an attention mechanism to focus on particular timesteps of relevance to a future timestep's predictive forecast. The DNN may use ensemble learning through data bagging and further consider additional external features during time series forecasting.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a computing and/or communication device that may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. Although only one client computing device is shown, a plurality of client computing device may function similarly.

Client device 110 of FIG. 1 contain an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may include one or more processes to execute software modules and associated components of client device 110 to provide features, services, and other operations to a user from service provider server 120 over network 140, which may include account, electronic transaction processing, and/or other computing services and features from service provider server 120. In this regard, application 112 may correspond to specialized software utilized by users of client device 110 that may be used to access a website or application (e.g., mobile application, rich Internet application, or resident software application) that may display one or more user interfaces that allow for interaction with service provider server 120, for example, to access an account, process transactions, and/or otherwise utilize computing services. In various embodiments, application 112 may correspond to one or more general browser applications configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other embodiments, application 112 may correspond to a dedicated application of service provider server 120 or other entity (e.g., a merchant) for transaction processing via service provider server 120.

Application 112 may be associated with account information, user financial information, and/or transaction histories for electronic transaction processing, including processing transactions using financial instrument or payment card data. Application 112 and/or another device application may be used to provide data that may be forecasted at a future time or timestep using time series forecasting provided by service provider server 120. Such data may correspond to forecast feature data 114 that may be used to train DNN models, such as using a LSTM recurrent neural network architecture. Forecast feature data 114 may include one or more data records, which may be stored and/or persisted in a database and/or data tables accessible by service provider server 120. In further embodiments, forecast feature data 114 may also or instead be used as input data to a trained DNN model, which may utilize forecast feature data 114 for time series forecasting of a trait, variable, feature, or the like at a future time and/or timestep. Additionally, application 112 may be used to view the results of time series forecasting by service provider server 120. For example, application 112 may be used to view a predicted total payment volume, revenue and/or changes in revenue, or other parameter forecasted at a future timestep that may be associated with a user, merchant, account, entity, or the like. In some embodiments, this may correspond to the results of timestep forecasting for a business entity, such as future earnings, stock price forecasts and/or forecasts of data that may affect stock price, company valuation, and the like.

Application 112 may be utilized to enter, view, and/or process items the user wishes to purchase in a transaction, as well as perform peer-to-peer payments and transfers. In this regard, application 112 may provide transaction processing through a user interface enabling the user to enter and/or view the items that the users associated with client device 110 wish to purchase. Thus, application 112 may also be used by a user to provide payments and transfers to another user or merchant, which may include transmitting forecast feature data 114 to service provider server 120. For example, accounts and electronic transaction processing may include and/or utilize user financial information, such as credit card data, bank account data, or other funding source data, as a payment instrument when providing payment information to service provider server 120 for the transaction. Additionally, application 112 may utilize a digital wallet associated with an account with a payment provider as the payment instrument, for example, through accessing a digital wallet or account of a user through entry of authentication credentials and/or by providing a data token that allows for processing using the account. Application 112 may also be used to receive a receipt or other information based on transaction processing. Further, additional services may be provided via application 112, including social networking, media posting or sharing, microblogging, data browsing and searching, online shopping, and other services available through service provider server 120. In some embodiments, the services provided via application 112 may be associated with receipt of information associated with time series forecasting, such as marketing, recommendations, next-best-actions, and/or other messages to increase customer engagement, alert and/or prevent against fraud, increase customer lifetime value, and/or otherwise provide services to users based on a predictive forecast of a trait, variable, feature, or the like provided by time series forecasting of service provider server 120.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying a user and/or client device 110 to service provider server 120. Moreover, database 116 may store forecast feature data 114, which may be provided to service provider server 120 for use during time series forecasting of a trait, variable, feature, or the like associated with client device 110 (e.g., a user, account, activity, etc., timestep forecast). Thus, forecast feature data 114 may be used for intelligent decision-making, forecasting, and classification by DNN models, and/or providing recommendations, marketing, and the like based on the time series forecasting and DNN models.

Client device 110 includes at least one network interface component 118 adapted to communicate with service provider server 120 and/or another device or server. In various embodiments, network interface component 118 may each include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide operations for use of service provided by service provider server 120 including account and electronic transaction processing services. In this regard, service provider server 120 includes one or more processing applications which may be configured to interact with client device 110 to provide computing and customer services based on time series forecasting using a DNN model. In various embodiments, use of the time series forecasting may be used to provide information, messages, and/or computing services to users and other entities of service provider server 120. In one example, service provider server 120 may be provided by PAYPAL®, Inc. of San Jose, Calif., USA. However, in other embodiments, service provider server 120 may be maintained by or include another type of service provider.

Service provider server 120 of FIG. 1 includes a predictive forecasting application 130, service applications 122, a database 126, and a network interface component 128. Predictive forecasting application 130 and service applications 122 may correspond to executable processes, procedures, and/or applications with associated hardware. In other embodiments, service provider server 120 may include additional or different modules having specialized hardware and/or software as required.

Predictive forecasting application 130 may correspond to one or more processes to execute modules and associated specialized hardware of service provider server 120 to provide computing services to users for time series forecasting and determination of predictive forecasts at a future time or timestep. In this regard, predictive forecasting application 130 may correspond to specialized hardware and/or software used by a user associated with client device 110 to utilize one or more services for time series forecasting using one or more DNNs including LSTM architectures based on input feature data having data records associated with one or more timestep during a time period (e.g., series of timesteps) for a user, account, activity, or the like. In this regard, predictive forecasting application 130 may utilize DNN models, such as LSTM models 132 having trained layers 134, with feature data 136 to determine and output predictive forecasts 138.

For example, LSTM models 132 may initially be trained using training data and features determined and/or extracted from data tables and/or data records of the training data. LSTM models 132, once trained, may be used for time series forecasting of a trait, feature, variable, or other information based on trained layers 14 that are trained and optimized for LSTM models 132. LSTM models 132 may be trained to provide a predictive output, such as a score, likelihood, probability, or decision, associated with a particular prediction, classification, or categorization of a future forecast for data associated with a user, account, entity, activity, or the like. For example, LSTM models 132 may include DNN, ML, or other AI models trained using training data having data records. When building LSTM models 132, training data may be used to generate one or more classifiers and provide recommendations, predictions, or other outputs for time series forecasting of predictive forecasts at a future time or timestep based on those classifications and an ML or NN model algorithm and architecture. The algorithm and architecture for training LSTM models 132 may correspond to an LSTM recurrent neural network architecture. Use of an LSTM architecture may provide benefits for temporal-based predictions for data that may change over a time period and/or predictions of future forecasts that may be time-sensitive to past temporal data.

The training data may be used to determine features, such as through feature extraction using the input training data. For example, DNN models for LSTM models 132 may include one or more of trained layers 134, including an input layer, a hidden layer, and an output layer having one or more nodes, however, different layers may also be utilized. As many hidden layers as necessary or appropriate may be utilized and the hidden layers may include one or more layers used to generate an output vector or embedding that may be used as an input to another DNN model. For example, when performing time series forecasting at different timesteps, instead of using an output trait, feature, or variable, a layer prior to the predictive output, such as a layer that includes one or more output scores, calculations, or values, may be used. This may simplify the input to LSTM models 132 for performing another timestep predictive forecasting and/or when calculating previous outputs of LSTM models 132 over a time period. For example, an output vector may be used as input without feature extraction being required by providing an embedding or vector that may be processed using the layers of LSTM models 132. Each node within a layer is connected to a node within an adjacent layer, where a set of input values may be used to generate one or more output values or classifications. Within the input layer, each node may correspond to a distinct attribute or input data type that is used to train LSTM models 132, for example, using feature or attribute extraction with the training data.

Thereafter, the hidden layer(s) may be trained with these attributes and corresponding weights using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for LSTM models 132 that attempt to classify and/or categorize the input feature data and/or data records (e.g., for a user, account, activity, etc., which may be a predictive score or probability for a predictive forecast at a future time or timestep). One-hot encoding may also be used with output scores to provide the output prediction or classification. Thus, when LSTM models 132 are used to perform a predictive analysis and output, the input of feature data 136 may provide a corresponding output for predictive forecasts 138 based on the classifications trained for LSTM models 132.

Trained layers 134 of LSTM models 132 may be trained by using training data associated with data records and a feature extraction of training features. In various embodiments, the training data may be “bagged” where randomization and/or selection of subsets of data records and/or tables from training data may be performed. These subsets include portions of data from the training data and may individually be used to generate different ones of LSTM models 132. This may be used with ensemble learning by combining these different ones of LSTM models 132 into a combined model. Data bagging in this manner may be used to generate multiple DNN models, such as different ones of LSTM models 132, which may be combined into a testable and/or deployable model. Data bagging may therefore be used to reduce noise in the training data and/or provide a more robust and/or accurate DNN model. By providing training data to train LSTM models 132, the nodes in the hidden layer may be trained (adjusted) such that an optimal output (e.g., a classification) is produced in the output layer based on the training data. By continuously providing different sets of training data and penalizing LSTM models 132 when the output of LSTM models 132 is incorrect, LSTM models 132 (and specifically, the representations of the nodes in the hidden layer) may be trained (adjusted) to improve its performance in data classification. Adjusting LSTM models 132 may include adjusting the weights associated with each node in the hidden layer.

During training of trained layers 134, in addition to data bagging for ensemble learning and/or generation of multiple DNN models, further operations and features may be used. For example, one or more attention mechanism and/or layers, as well as external features, may be used. With an attention mechanism, direct attention or focus may be made between an input and an output. In natural language processing and/or translation, two words may be strongly correlated, such as “Hi” and “Hola” when converting English to Spanish. With time series forecasting, an input timestep or feature associated with a timestep (e.g., a time, date, season, year, etc.) may be of particular relevance to a future predictive forecast at the same or similar timestep. For example, if the desired output of a predictive forecast is for a Monday, previous input timestep data on previous Mondays may be of highest relevance and therefore provided additional weight or focus when determining the predictive forecast for time series forecasting. Thus, the attention mechanism may provide additional weights to different input features for a timestep and corresponding nodes in order to provide a particular output at a corresponding timestep. The attention mechanism may also be multilayer and/or multipronged to focus on additional input features as having an effect on a corresponding output predictive forecast.

Additionally, external features may also be used for the training data, which may correspond to features not related to the particular input feature that is being forecasted. For example, with TPV or revenue, the main input feature may correspond to TPVs or revenues calculated on previous timesteps. However, other external features may be relevant to time series forecasting, such as customer data, fraud data, transaction data, a macro-economical feature, a trend in an e-commerce industry, a pandemic effect feature, a total payment volume migration feature, or a combination thereof. Thus, these external features may also be used for training. However, to reduce noise and provide more accurate forecasting, a limit on external features may also be set or imposed. The attention mechanism may also be used with other external features to draw particular attention to those features during time series forecasting. For example, where previous fraud data may be most relevant, fraud data occurring during previous timesteps may be provided additional weight during time series forecasting.

Thus, the training data may be used as input data sets that allow for LSTM models 132 to make classifications and predictive forecasts based on attributes and features. Once trained, feature data 136 may be used as input in order to determine predictive forecasts 138. The attention mechanism may provide different weights to portions of feature data 136 used as input that are relevant to the corresponding output forecast. Further, feature data 136 may also include data associated with the external features trained for LSTM models 132. Using the time series forecasting, a predictive forecast for a trait, feature, or variable may be provided at one or more future times or timesteps. The predictive forecast(s) may be used with service applications 122 in order to provide one or more services, offers, notification, or messages associated with the forecasted data.

Service applications 122 may correspond to one or more processes to execute modules and associated specialized hardware of service provider server 120 to process a transaction or provide another service to customers, merchants, and/or other end users and entities of service provider server 120. In this regard, service applications 122 may correspond to specialized hardware and/or software used by service provider server 120 to providing computing services to users, which may include electronic transaction processing and/or other computing services using accounts provided by service provider server 120. In some embodiments, service applications 122 may be used by users associated with client device 110 to establish user and/or payment accounts, as well as digital wallets, which may be used to process transactions. In various embodiments, financial information may be stored with the accounts, such as account/card numbers and information that may enable payments, transfers, withdrawals, and/or deposits of funds. Digital tokens for the accounts/wallets may be used to send and process payments, for example, through one or more interfaces provided by service provider server 120. The digital accounts may be accessed and/or used through one or more instances of a web browser application and/or dedicated software application executed by client device 110 and engage in computing services provided by service applications 122. Computing services of service applications 122 may also or instead correspond to messaging, social networking, media posting or sharing, microblogging, data browsing and searching, online shopping, and other services available through service provider server 120.

In various embodiments, service applications 122 may be desired in particular embodiments to provide features to service provider server 120. For example, service applications 122 may include security applications for implementing server-side security features, programmatic client applications for interfacing with appropriate application programming interfaces (APIs) over network 140, or other types of applications. Service applications 122 may contain software programs, executable by a processor, including a graphical user interface (GUI), configured to provide an interface to the user when accessing service provider server 120 via one or more of client device 110, where the user or other users may interact with the GUI to view and communicate information more easily. In various embodiments, service applications 122 may include additional connection and/or communication applications, which may be utilized to communicate information to over network 140.

Additionally, service applications 122 may be used to provide a service or other information to one or more users or accounts based on time series forecasting performed by predictive forecasting application 130. In this regard, service applications 122 may be used to provide forecasting options 124, such as information and/or options provided to client device 110 based on predictive forecasts 138. Forecasting options 124 may include providing a computing service and/or may further include transmitting or providing a message, notification, offer, or the like for the corresponding computing service and/or action. Forecasting options 124 may also include options to provide and/or generate reports on forecasted data, such as those that may be associated with a total payment volume and/or revenue of a customer, merchant, or the like. Forecasting options 124 may also provide predicted earnings and/or forecasted quarterly financial information for one or more business entities.

Service provider server 120 further includes database 126. Database 126 may store various identifiers associated with client device 110. Database 126 may also store account data, including payment instruments and authentication credentials, as well as transaction processing histories and data for processed transactions. Database 126 may store financial information or other data generated and stored by predictive forecasting application 130. Database 126 may also include data and computing code, or necessary components for LSTM models 132. Database 126 may also include training data and/or feature data 136 having data records, which may include forecast feature data 112 provided by client device 110.

In various embodiments, service provider server 120 includes at least one network interface component 128 adapted to communicate client device 110 and/or other devices or server over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

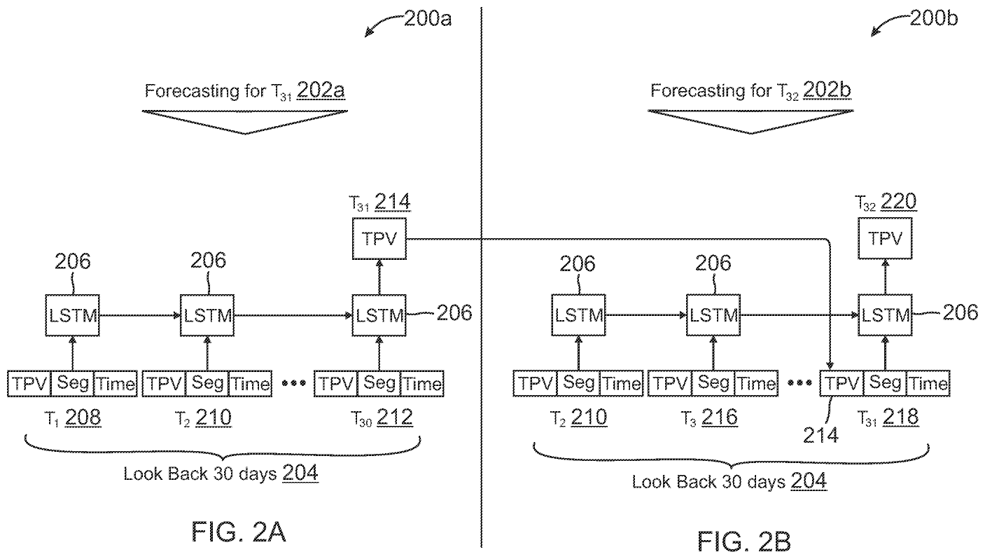

FIGS. 2A and 2B are exemplary architectures 200a and 200b of a time series model providing predictive forecasts of total payment volumes at future times, according to embodiments. Architectures 200a and 200b include time forecasting 202a and 202b that may be performed by service provider server 120 discussed in reference to system 100 of FIG. 1 using the time series forecasting discussed herein with DNN models. In this regard, service provider server 120 may train and deploy a DNN model, such as LSTM models 132 in system 100, to determine predictive forecasts at future times or timesteps based on data from past timesteps, external features or segments, and the forecasted trait, feature, or variable.

In architecture 200a, time series forecasting 202a occurs for a time T₃₁ occurring after a time period T₁-T₃₀, which corresponds to a look-back period 204 of 30 days. LSTM model 206 may correspond to a trained DNN model using an LSTM architecture, where LSTM model 206 may be trained using the attention mechanism, data bagging, and/or external features described herein. For example, with sequence-to-sequence (seq2seq) DNN models and predictions, such as an encoder-decoder model, the attention mechanism may be used to draw a parallel between a specific input and a corresponding output, such as by linking past timesteps (e.g., past days of the week, months, seasons, or the like) with a corresponding future timestep. In this regard, LSTM model 206 may be trained in order to provide future time series forecasting for timesteps occurring after look-back period 204. On a first day 208 of T₁, LSTM model 206 may take as input a total payment volume (TPV), an external factor corresponding to a segment (e.g., a segment of a population, demographic, group of customers or merchants, or the like, although other external factors may also be used), and a time (e.g., a time corresponding to the timestep of T₁. This may correspond to feature data used as input to LSTM model 206. LSTM model 206 may then calculate a corresponding output, which may be a future predictive forecast of TPV for the customer, merchant, or the like.

However, to calculate time series forecasting based on temporal data, where the TPV, segment, and/or other data may change over the timesteps in look-back period 204, additional timesteps are used. As such, feature data on a second day 210 of T₂ is further used, which may similarly correspond to the TPV, segment, and time on T₂. Further, as input LSTM model 206 may consider the output from first day 208 on T₁. This may be provided as further input to LSTM model 206. In some embodiments, the predicted TPV may be provided as input, or a score, value, or other vector for an output prior to the predictive forecast (e.g., prior to one-hot encoding or the like). With seq2seq models, an output may instead correspond to an embedding or vector instead of the actual forecast, which may more easily be used as the input to when determining the next total payment volume or other model output. Thus, the output may not be the decision or prediction but instead a condensed version of the data in a hidden state that may be provided or fed to the next day with LSTM model 206.

Thereafter, LSTM model 206 provides another predicted TPV forecasted at a future timestep. This continues on each timestep (e.g., each day) until day thirty 212 on T₃₀, where LSTM model 206 then takes the input vector from the previous day with the feature data and predicts a TPV at a future timestep 214 on T₃₁ occurring after look-back period 204. Thus, a predictive forecast at future timestep 214 for time series forecasting using the DNN model discussed herein is provided. In some embodiments, the timesteps may be different than a day and/or rely on different time periods. For example, an hour, a month, a season, or the like may be used as the time period and LSTM model 206 may proceed using predictive forecasts for those time periods.

LSTM model 206 may further be used to provide additional time series forecasting at timesteps past day T₃₁ by using the forecasted TPV from future timestep 214 and calculating a TPV at one or more future times or timesteps. For example, architecture 200b includes time forecasting 202b that may be for a future timestep after T₃₁. LSTM model 206 may consider look-back period 204 now from second day 210 on T₂ through future timestep 214 on T₃₁. Thus, instead of the first two input timesteps occurring on days T₁ and T₂, instead the first two input timesteps occur on days T₂ and T₃. Thus, third day 216 on T₃ is shown in time forecasting 202b as the second forecasted TPV. The TPV predictively forecasted for final day 218 on T₃₁ is now used as the final day to calculate a forecasted TPV on a future timestep 220 of T₃₂. As before, a condensed version of the data in a hidden state, embedding, or vector may be used as the input when calculating and/or predicting TPV at future timestep 220. Thus, LSTM model 206 may be used to iteratively determine multiple future predictive forecasts during time series forecasting.

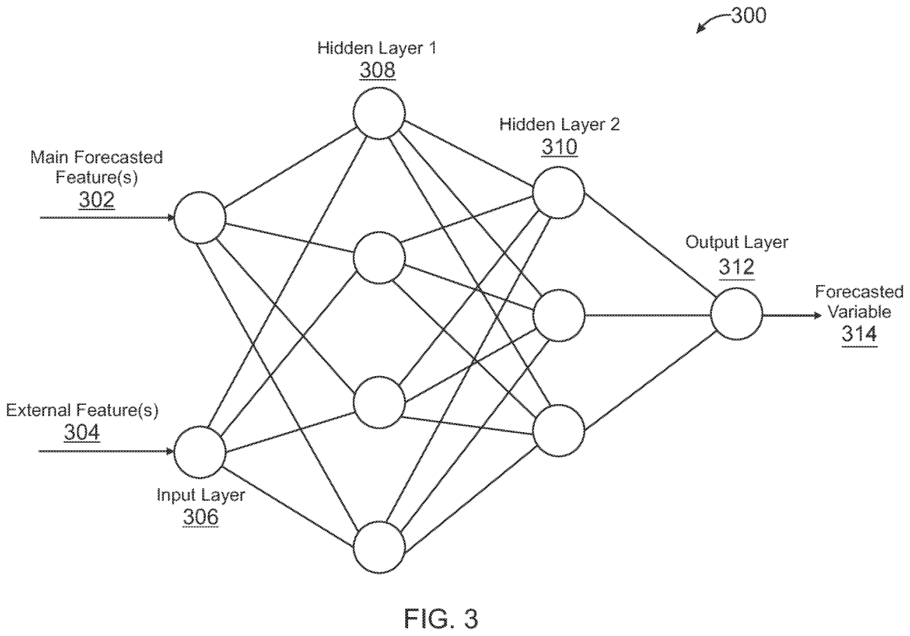

FIG. 3 is an exemplary deep neural network (DNN) 300 used for time series forecasting, according to an embodiment. DNN 300 includes a model having different layers trained from input training features to provide an output predictive forecast or classification at an output layer, which may be performed based on values or scores determined from the hidden layers of the model. In this regard, the output of the model for DNN 300 may be used for time series forecasting based on main forecasted feature(s) 302 and external feature(s) 304 of a future trait, variable or feature that may correspond to a user, account, trend, event, activity, or other data.

In this regard, DNN 300 includes an input layer 306, a first hidden layer 308, a second hidden layer 310, and an output layer 312, which may provide a forecasted variable 314. Further, DNN 300 may be used to perform time series forecasting. Input layer 306 may correspond to a layer that takes input data for features, such as past total payment volumes from FIGS. 2A and 2B, however, any other type of time forecasted variable may also be used (e.g., revenue, future earnings, as well as non-financial forecasted variables associated with users, accounts, entities, activities, and the like). The data may be parsed and processed, and feature data for the particular features of DNN 300 extracted and used as main forecasted feature(s) 302 at input layer 306. Additionally, additional feature data for external feature(s) 304 may also be provided at input layer 306. Using the trained weights, values, and mathematical relationships between nodes in input layer 306 and nodes in first hidden layer 308 and second hidden layer 310, encodings, embeddings, decisions, and other hidden layers may be generated as mathematical representations (e.g., vectors) of the input feature data. First hidden layer 308 may then be connected to second hidden layer 310, which may generate further encodings and/or embeddings of the feature data. These may be used may be used to create decisions, such as based on the trained weights and relationships between nodes, which are provided as output scores, values, or other data at output layer 312 Using one-hot encoding or other data conversion operation, forecasted variable 314 may be provided as the output of DNN 300 based on the data from output layer 312.

When training DNN 300, data bagging, or bootstrap aggregation, may be performed to generate subsets of data from the training data. Data bagging may correspond to a process where the training data is used to generate subsets of the training data having randomly or procedurally selected data records and/or tables from the training data. Each new subset of the training data corresponds to a portion of the training data and may be generated in order to reduce noise in the training data and have different DNN, such as LSTM architecture, models trained using different training data. Thereafter, the subsets of the training data may be used to train different DNN models, where the trained models are then combined or otherwise processed in order to create DNN 300.

Initially after feature extraction and/or transformation for training the different DNN models and/or DNN 300, training data and a DNN architecture may perform cross validation, hyperparameter tuning, model selection, and the like for training DNN 300. This may include using an attention mechanism with past timesteps, as well as additional attention mechanisms for other features including external feature(s) 304. The attention mechanism may create a link or focus between an input feature and/or feature data and a corresponding requested output. For example, with timesteps, the attention mechanism may be used to focus DNN 300 (and/or the corresponding DNN models created from the data bagging of the training data) on corresponding past timesteps. In this regard, if the requested variable to be forecasted occurs at a specific time or on a corresponding timestep (e.g., past day of the week, month, season, etc.), DNN 300 and/or the corresponding other DNN models may focus on the data occurring on the same or similar past timesteps.

When executing DNN 300, feature transformation may then be used with the input data and DNN 300 to generate a prediction, classification, and/or categorization, which may correspond to a predictive score or probability associated with the input data. The input data may correspond to one or more data records, which each having different input features having a number of features. In DNN 300, the input features may correspond to main forecasted feature(s) 302, such as data associated with an output forecast (e.g., a total payment volume, revenue, earnings, etc., that may be forecasted) and time or timestep data (e.g., a timestamp, date, timestep period, etc.). The input features may also include external feature(s) 304. Using this feature data and the layers of DNN 300, forecasted variable 314 may be output, which may be the predictive forecast of a feature, trait, or variable that is associated with main forecasted feature(s) 302 at a future time or timestep. Forecasted variable 314 may further be affected by external feature(s) 304.

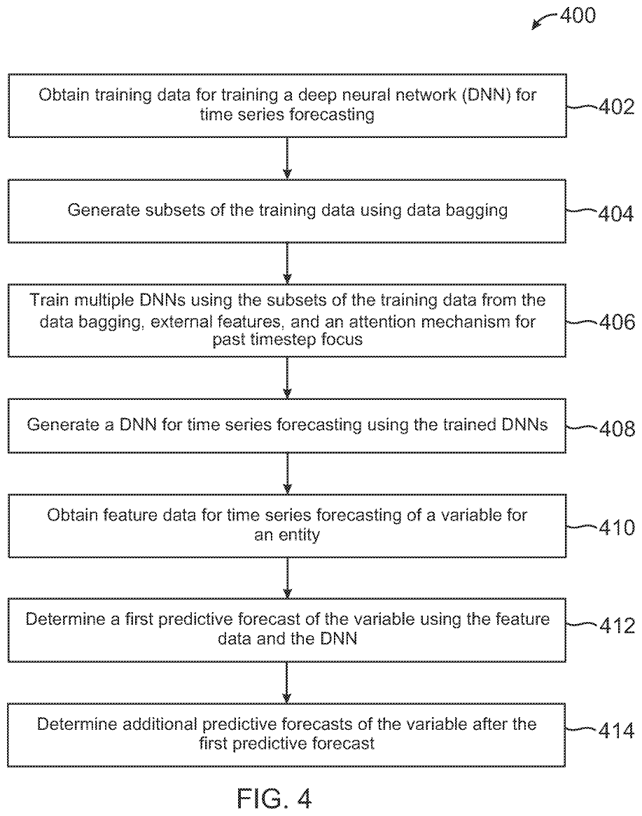

FIG. 4 is a flowchart 400 for an attention mechanism and dataset bagging for time series forecasting using deep neural network models, according to an embodiment. Note that one or more steps, processes, and methods described herein of flowchart 400 may be omitted, performed in a different sequence, or combined as desired or appropriate.

At step 402 of flowchart 400, training data for training a DNN for time series forecasting is obtained. In order to train the DNN, such as using a LSTM recurrent neural network architecture, training data may be determined, which may correspond to input data utilized for an output prediction or classification. The training data may correspond to a particular set of data, such as data tables having rows for different data records of one or more users, entities, accounts, or activities, and columns for one or more features in a set of features to be provided as the input features and/or feature extraction for training the DNN model. The training data may correspond to a main feature or variable that is to be forecasted at a future time, such as information for a user, account, entity, or the like. For example, the variable may be associated with future financial performance, future activities, future behaviors, or other future information.

At step 404, subsets of the training data are generated using data bagging. Data bagging may be performed to aggregate subsets of the data records into smaller training data sets that do not include all of the data records from the training data set. Thus, each bagged data set from the training data includes a subset of the data records and may be used to reduce noise when training different DNN models. However, another data set may include all data records in the training data set in order to provide additional training robustness to the training data sets from the data bagging.

At step 406, multiple DNNs are trained using the subsets of the training data from the data bagging, external features, and an attention mechanism for past timestep focus. Each DNN may be trained based on the subsets of data generated from the data bagging with the training data. When training the DNN, hidden layers of each DNN model may be trained, adjusted, and/or have nodes reweighted using an attention mechanism, which may specifically focus on past timesteps of relevance to a future predictive forecast at a corresponding timestep. Thus, the attention mechanism may be used by each DNN to make correlations and/or provide additional weights to past timesteps when a corresponding timestep is to be forecasted for the predicted variable. Additionally, external features may be added to the training data for the DNNs, which may be external events, activities, and other data that may affect forecasting a variable. This may be selectable by a data scientist and/or modeler based on external data that may affect the variable forecasting.

At step 408, a DNN for time series forecasting is generated using the trained DNNs, such as those from step 406. Using ensemble learning or other suitable techniques, a combination of the DNNs generated from the bagged subsets of the training data may be used to create a more robust and/or accurate DNN for time series forecasting. This DNN may take the benefits of each DNN trained on the corresponding subset of the training data. At step 410, feature data for time series forecasting of a variable for an entity is obtained. The feature data may correspond to data for the input features (e.g., the feature or variable being forecasted at a future timestep), as well as any additional data for external features. In some embodiments, the feature data may correspond to data over a previous time period, which includes multiple timesteps that allow for predictive forecasting at a corresponding future timestep. For example, the feature data may include a total payment volume for a user over a previous look-back period of thirty days.

At step 412, a first predictive forecast of the variable is determined using the feature data and the DNN. Feature extraction on the feature data may be performed and an input layer of the DNN may take the data for the features and process using the hidden layers to provide a predictive forecast at an output layer. To provide this forecast, the DNN, such as an LSTM recurrent neural network architecture, may process the feature data at each previous timestep consecutively or in series (e.g., successively, starting at the first timestep in the look-back period and proceeding successively through the next timesteps to the last timestep). This allows for an output of the DNN to be generated at each previous timestep, where an output of that previous timestep is used as an input for the DNN at the next timestep. Each output may also be provided in a hidden state as a condensed version of the data for processing by the DNN with the data for the next timestep. When arriving at the last timestep, the previous timestep's output is used and a predictive forecast of the feature or variable at the next timestep occurring at a future time.

At step 414, additional predictive forecasts of the variable are determined after the first predictive forecast. After the forecasted timestep, additional future timesteps may also be forecasted. For example, the previous look-back period may be thirty days, and at a future day, day thirty-one, a predictive forecast of a variable may be determined at step 412. Thereafter, a day thirty-two (or further timesteps) predictive forecast may be requested. In such embodiments, the predictive forecast from step 412 may also be used as input when determining the additional predictive forecast at the further future timesteps. The look-back period may also be adjusted to account for moving forward through the predictive forecasts at the future timesteps. In this manner, a service provider may provide a more robust and accurate DNN for time series forecasting.

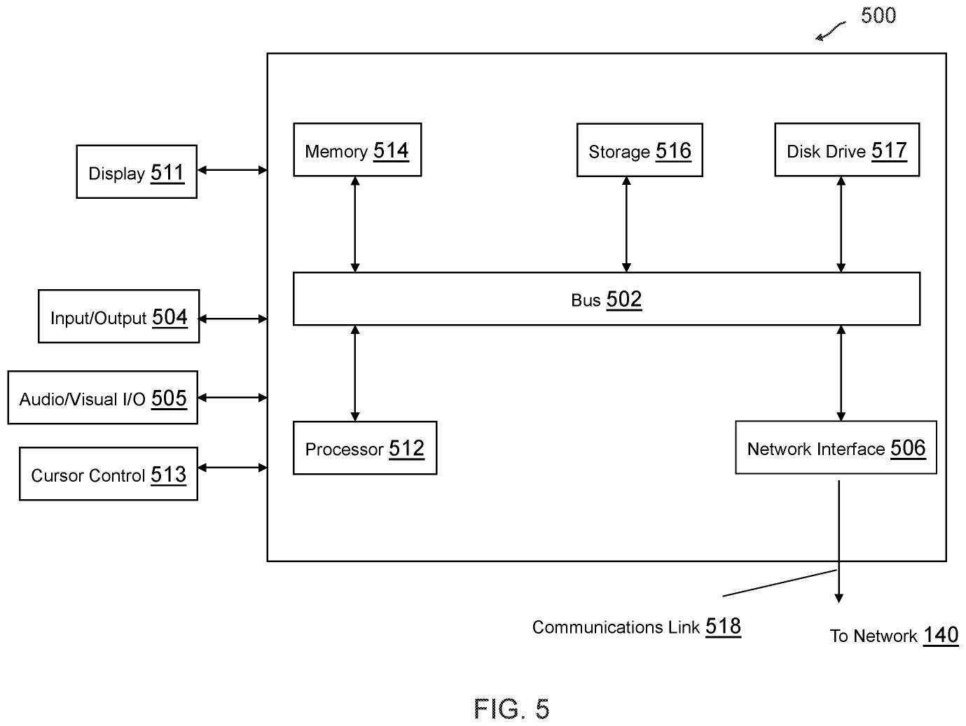

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
obtaining feature data for features of an entity, wherein the feature data comprises time-based data for at least one of the features over a plurality of timesteps within a time period;
accessing an intelligent forecasting framework comprising a deep neural network model configured to enable a time series forecasting associated with the entity, wherein the deep neural network model is trained by the intelligent forecasting framework using training data associated with the features and an attention mechanism that identifies one or more importance levels for one or more timesteps of the plurality of timesteps based on the training data, and wherein the deep neural network model comprises a combined model based on a plurality of deep neural network models trained on subsets of the training data generated using data bagging with the training data;
determining a first predictive forecast for the entity at a first time after the time period using the feature data and the deep neural network model, wherein the first predictive forecast is further determined using a plurality of predictions determined by the deep neural network model over the time period from the feature data and the one or more importance levels for the attention mechanism and one or more of the plurality of timesteps associated with the first time; and
determining a second predictive forecast for the entity at a second time after the first time using the feature data, the first predictive forecast, and the deep neural network model, wherein the second predictive forecast is further determined using and the one or more importance levels for the attention mechanism and one or more of the plurality of timesteps associated with the second time.

2. The service provider system of claim 1, wherein the deep neural network model uses a long short-term memory (LSTM) recurrent neural network architecture.

3. The service provider system of claim 1, wherein the attention mechanism comprises an architecture that provides one or more weights to the one or more timesteps of the features when providing the time series forecasting of a future timestep.

4. The service provider system of claim 3, where the attention mechanism is one of a plurality of attention mechanisms for different layers of the deep neural network model.

5. The service provider system of claim 1, wherein the time-based data comprises data points for at least a portion of the feature data for the features collected over the time period.

6. The service provider system of claim 1, wherein prior to obtaining the feature data, the operations further comprise:
generating, using the data bagging, at least one additional training data sets from the training data for the features of the deep neural network model, wherein the at least one additional training data sets comprises a subset of data records in the training data randomly selected using the data bagging.

7. The service provider system of claim 1, wherein prior to obtaining the feature data, the operations further comprise:
training the deep neural network model using the training data associated with the features and an LSTM recurrent neural network architecture.

8. The service provider system of claim 7, wherein the training the deep neural network model utilizes the attention mechanism and the data bagging associated with the training data.

9. The service provider system of claim 7, wherein the training the deep neural network model utilizes at least one external feature of the features that is separate from a variable being forecasted by the time series forecasting for at least the first predictive forecast and the second predictive forecast.

10. The service provider system of claim 1, wherein the features comprises an input feature for the time series forecasting of a corresponding output feature at a future time, wherein the input feature comprises one of a total payment volume, a future revenue, a purchase amount, or a transaction parameter, wherein the features further comprise at least one input external feature for use with the time series forecasting of the corresponding output feature, and wherein the at least one input external features comprises at least one of customer data, fraud data, transaction data, a macro-economical feature, a trend in an e-commerce industry, a pandemic effect feature, or a total payment volume migration feature.

11. A method comprising:
determining, using a deep neural network model used configured to enable time series forecasting of a trait of an entity at one or more future times, a plurality of past traits for the entity over a time period using feature data over the time period for features processed by the deep neural network model, wherein the deep neural network model is trained using an attention mechanism and data bagging for training data associated with the features;
determining, using the deep neural network model, a first predictive forecast of the trait at a first future time after the time period based on the feature data, the plurality of past traits, and a temporal factor; and
determining, using the deep neural network model, a second predictive forecast of the trait for the entity at a second future time after the first future time based on the feature data, the first predictive forecast, the plurality of past traits, and the temporal factor.

12. The method of claim 11, wherein the deep neural network model is trained using a long short-term memory (LSTM) recurrent neural network architecture with the attention mechanism and the data bagging.

13. The method of claim 11, wherein the trait comprises a forecasted variable at the one or more future times.

14. The method of claim 13, wherein the forecasted variable comprises one of a total payment volume, a future revenue, a purchase amount, or a transaction parameter.

15. The method of claim 11, how the first predictive forecast comprises a vector provided as an input feature for the deep neural network model during the determining the second predictive forecast.

16. The method of claim 11, wherein the determining the plurality of past traits of the entity over the time period comprises determining a plurality of vectors at different past times over the time period, and wherein each of the plurality of vectors are used as an input when determining a next one of the plurality of past traits by the deep neural network model.

17. A non-transitory machine-readable medium having stored thereon machine-readable instructions executable to cause a machine to perform operations comprising:
receiving training data for model features of a long short-term memory (LSTM) neural network model, wherein the training data is associated with a time period and comprises temporal data for the model features over the time period, and wherein the LSTM neural network model is configured to enable a predictive forecasting of a future predicted trait;
performing data bagging of data records for the model features in the training data;
determining additional feature data for additional features used for training the LSTM neural network model for the future predicted trait; and
training the LSTM neural network model using the training data, the data bagging, the additional feature data, and an attention mechanism for identifying one or more features for a focus during training of the LSTM neural network model.

18. The non-transitory machine-readable medium of claim 17, wherein the performing the data bagging comprises generating a plurality of data sets of the data records for the training the LSTM neural network model.

19. The non-transitory machine-readable medium of claim 17, wherein the attention mechanism applies one or more weights to the training data for the training the LSTM neural network model for the predictive forecasting of the future predicted trait.

20. The non-transitory machine-readable medium of claim 17, wherein the training data further comprises customer data over the time period associated with customers of a service provider, and wherein the future predicted trait comprises a total payment volume.
